(19) United States
(12) Patent Application Publication
(10) Pub. No.: US 2026/0131402 A1
(43) Pub. Date: May 14, 2026

(54) METHOD FOR LASER TREATMENT OF A HOROLOGY COMPONENT

(71) Applicant: Rubattel & Weyermann S.A., La Chaux-de-Fonds (CH)

(72) Inventors: Frédéric JEANRENAUD, La Chaux-de-Fonds (CH); Stéphane DE JESUS, La Chaux-de-Fonds (CH); Adis KULJANCIC, La Chaux-de-Fonds (CH); Giovanni POLY, Maiche (FR)

(73) Assignee: Rubattel & Weyermann S.A., La Chaux-de-Fonds (CH)

(21) Appl. No.: 19/367,259

(22) Filed: Oct. 23, 2025

(30) Foreign Application Priority Data
Nov. 13, 2024 (EP) 24212768.6

(51) Int. Cl. B23K 26/362; B44C 3/00; G04D 3/00

(52) U.S. Cl. CPC B23K 26/362; B44C 3/005; G04D 3/0069

(57) ABSTRACT

A method for laser treatment of a horology component (10) including an operation for treating a surface of the horology component (10) inscribed in an orthonormal XYZ coordinate system, in which a laser (20) is controlled to emit a laser beam (21) and to move a focal point (210) of the laser beam (21) in order to impact a surface to be treated (100) on the horology component (10) in response to control instructions from a computer program, in order to follow a scanning strategy including a plurality of paths (31), each having a component in a Z direction and a component in at least one of the X or Y directions, the scanning strategy being defined such that the energy density emitted by the laser beam (21) varies over the entire surface to be treated (100).

### CROSS-REFERENCE TO RELATED APPLICATIONS

This application claims priority to European Patent Application No. 24212768.6, filed on Nov. 13, 2024, the entire contents of which are incorporated herein by reference.

### TECHNICAL FIELD OF THE INVENTION

The invention relates to the field of timepiece decoration.

More specifically, the invention relates to a method for laser treatment of a horology component. For example, such a component can consist of a dial, an applique, a hand, a plate, a bar, an oscillating mass, a bezel, a case middle, or any other visible component on a watch.

### TECHNOLOGICAL BACKGROUND

Laser treatment methods for horology components have been known for years. Such laser treatment methods make it possible to decorate the surface of the components, in particular by colouring or structuring them, or in other words, by changing the state of the surface of the components, or even by changing the shape of the surface by removing material to create recesses such as “côtes de Gen\grave{v}e.” Laser treatment methods can also be used to remove a layer from a surface.

To carry out surface treatments, the lasers are controlled to emit a series of laser beam impulses in order to move the beam's focal point in a scanning plane relative to the surface to be treated, following a scanning strategy. This strategy depends on the surface treatment to be carried out and takes various laser beam parameters into account, including the focal point paths.

When the surface to be treated has a complex geometry, for example, if it has a three-dimensional shape, between two successive series of impulses, the focal point of the beam is shifted along a path orthogonal to the scanning plane such that the series of impulses are carried out in separate scanning planes that are parallel to each other. In other words, with each pass, the focal point is shifted in a direction normal to the surface to be treated, for example by a distance of around one micrometre.

Thus, at the micrometric scale, the treated surface has several levels of different thicknesses forming shoulders 1, as shown in FIG. 1.

These shoulders 1, which are a few micrometres high, for example 5 μm, are difficult to see with the naked eye but are clearly visible under a magnifying glass and are therefore not suitable for horology components intended for use in high-end watches.

Moreover, decorative gradients, such as colour gradients or textured gradients, are created by scanning the laser beam in such a way that it generates sets of impact points distributed according to different densities.

These impact points are visible to the naked eye and create a pixelated effect on the decoration that is scarcely compatible with high-end watches.

There is a need to be able to carry out laser treatments on horology components with a suitable appearance at the micrometric scale.

### SUMMARY OF THE INVENTION

To this end, the invention relates to a method for laser treatment of a horology component comprising an operation for treating a surface of the horology component inscribed in an orthonormal XYZ coordinate system, in which a laser is controlled to emit a laser beam and to move a focal point of the laser beam in order to impact a surface to be treated on the horology component in response to control instructions from a computer program, in order to follow a scanning strategy comprising a plurality of paths each having a component in a Z direction and a component in at least one of the X or Y directions, the scanning strategy being defined such that the energy density emitted by the laser beam varies over the entire surface to be treated.

The features of the invention make it possible to decorate the surface to be treated on the substrate by creating a decorative gradient effect, that is, a colour gradient or a textured gradient, with no pixelation or shouldering.

In particular embodiments, the invention can further comprise one or more of the following features, taken separately or in any technically possible combination.

In particular embodiments, each of the paths has a curvilinear and/or rectilinear shape.

In particular embodiments, the treatment operation is carried out by a laser consisting of a numerically-controlled machine tool formed by a frame and a work enclosure in which the horology component is disposed on a fitting.

In particular embodiments, the treatment operation is carried out so as to generate a colouration of the surface to be treated, the variation in the energy density of the laser beam causing a gradual and direct variation in the colour of said surface to be treated.

In particular embodiments, the treatment operation is carried out so as to produce a decoration through the ablation of a layer or of several layers of material deposited on the substrate, the variation in the energy density of the laser beam causing a direct change in the thickness of the layer on the surface of the substrate.

In particular embodiments, the surface to be treated is the surface of a metallic layer with a thickness comprised between 10 nm and 20 μm, the treatment operation being carried out such that the thickness of the layer is reduced until it is equal to a few tens of nanometers or until the layer is removed.

In particular embodiments, the surface to be treated is the surface of a thin layer of silicon oxide, titanium, aluminium, a carbon-based material, chromium, gold, silver, aluminium, copper or nickel, deposited by PVD, CVD or ALD, so as to have a thickness comprised between 10 nm and 500 nm, the treatment operation being carried out such that the horology component has an interference colour gradient.

In particular embodiments, the surface to be treated is the surface of a layer in a coating of thin layers comprising a metallic absorption layer deposited on the substrate and a transparent layer made of an oxide and deposited on the absorption layer, the treatment operation being carried out so as to ablate the transparent layer to locally reduce its thickness in order to locally change an interference colour generated by the coating of thin layers.

In particular embodiments, the surface to be treated is the surface of a layer deposited by pulverisation with a thickness comprised between 3 μm and 150 μm.

In particular embodiments, the surface to be treated is the surface of the substrate, the treatment operation being carried out such that said surface is structured so as to generate decorations in the form of reliefs with a uniform appearance on a micrometric scale, that is, with no aliasing effect.

### BRIEF DESCRIPTION OF THE FIGURES

Other features and advantages of the invention will become apparent from the following detailed description, given by way of non-limiting example, with reference to the attached drawings in which:

FIG. 1 schematically shows a surface that has been laser-treated using a method from the prior art, with several levels of different thicknesses forming shoulders.

FIG. 2 schematically shows a perspective view of a horology component with a surface to be treated by a laser treatment method according to a preferred example of the invention, and a reference surface formed by a plurality of paths of a scanning strategy of a laser beam and of the horology component relative to each other, in an XYZ coordinate system,

FIGS. 3a to 3c represent a scanning strategy according to an example of the method according to the present invention.

FIGS. 4 and 5 show two horology components obtained using the method according to different variants.

It should be noted that the figures are not drawn to scale for clarity reasons.

### DETAILED DESCRIPTION OF THE INVENTION

The invention relates to a method for laser treatment of a horology component 10. The horology component 10 comprises a substrate 11 made, for example, of a metallic material such as copper, steel, iron, aluminium, titanium, gold, silver, or their alloys, or made of a mineral material such as ceramic, sapphire, aventurine, onyx, or made of an organic material such as mother-of-pearl.

The method according to the invention uses a laser 20 comprising an optical system made up of mirrors and lenses through which a laser beam 21 is emitted by a laser source. In a manner known to the person skilled in the art, the optical system makes it possible to change, in particular, the energy delivered by the laser beam 21, its polarisation and its size. Advantageously, the optical system also comprises an optical deflection device controlled by an electronic control module that is known as such. The laser beam 21 is emitted in the form of impulses with a duration on the order of nanoseconds, picoseconds or femtoseconds.

The laser 20 used in the present invention is a numerically-controlled machine tool consisting of a frame and a work enclosure. The laser beam 21 is moved in response to control instructions from a pre-programmed computer programme according to the decoration to be made on the horology component 10. When using the method according to the invention, the horology component 10 is held in position on a fitting provided for this purpose inside the work enclosure.

All of these aspects are well known to the person skilled in the art and are therefore not described in further detail in this text. Only the information specific to the invention and differing from routine operations carried out by the person skilled in the art is therefore described in detail in this text.

The method comprises an operation for treating a surface of the horology component 10, in which the laser 20 is controlled so as to emit a laser beam 21 in order to impact a surface to be treated 100 on the horology component 10. During the surface treatment operation, a focal point 210 of the laser beam 21 is moved such that it scans the surface to be treated 100 by the optical deflection device as shown in FIGS. 3a to 3c, so as to follow a predetermined scanning strategy extending in three-dimensional space. As illustrated in FIGS. 2 to 3c, the horology component is inscribed in an orthonormal XYZ coordinate system and extends in an XY plane.

The scanning strategy comprises a plurality of paths 31 in which a series of impulses from the laser beam 21 is continuously emitted, each of which comprises a component in the Z direction and a component in at least one of the X or Y directions. For example, each of the paths 31 has a curvilinear and/or rectilinear shape.

The paths 31 are inscribed in a reference surface 30 extending in a three-dimensional space in the XYZ coordinate system, as schematically shown in perspective in FIG. 2. This reference surface 30 has a different shape from the surface to be treated 100, so that the energy density emitted by the laser beam 21 varies over the entire said surface to be treated 100.

Each path 31 corresponds to a path of the laser beam 21 as shown in FIGS. 2 to 3c, and in particular the path of the focal point 210 of the laser beam 21, relative to the horology component 10, the latter being held in position in the XYZ coordinate system by means of a suitable fitting. The control of the movement of the focal point 210 is known as such to the person skilled in the art.

Of course, the scanning strategy could define a scanning of the laser beam 21 in several parallel directions or in several non-parallel directions.

The scanning strategy is defined in a step in which the computer programme is programmed, prior to the surface treatment operation. The scanning strategy is defined such that the energy density emitted by the laser beam 21 varies over the entire surface to be treated 100. In particular, the scanning strategy depends largely on the decoration to be produced and on the shape of the surface 100 to be treated on the horology component 10, insofar as the closer the focal point 210 of the laser beam 21 is to the surface 100 to be treated, the more concentrated the laser beam 21 is on the surface to be treated 100 and accordingly the greater the level of energy to which it is exposed.

In FIGS. 2 to 3c, the surface to be treated 100 has a planish shape, extending only in the XY plane, but it could be of any shape. Furthermore, the surface to be treated 100 can constitute part or all of the surface of the substrate 11 or of a layer 12 deposited on the substrate 11.

By way of example, the laser treatment operation can be carried out with laser beam parameters 21 such that the decoration produced is a colouration of the substrate 11 or of a layer 12 deposited on the substrate, an ablation of a layer 12 or of several layers of material deposited on the substrate 11, a structuring of the substrate 11, etc.

When the decoration produced is a colouration of the substrate 11 or of a layer 12 deposited on the substrate 11, depending on whether the surface to be treated 100 is the surface of the substrate 11 or of the layer 12, the variation in the energy density of the laser beam 21 causes a gradual and direct variation in the colour of the surface to be treated 100. In fact, the colour of the surface to be treated 100 depends on its material and on the level of energy to which it is exposed.

When the method according to the invention is used to produce a decoration by ablation of at least one layer 12 deposited on the substrate 11, the variation in the energy density of the laser beam 21 causes a direct local change in the thickness of the layer 12 on the surface of the substrate 11, that is, in the XY plane in FIGS. 4 and 5, which show two exemplary embodiments of the method.

The layer or layers on which the surface is to be treated can be opaque, transparent or semi-transparent and can be deposited by any known method, such as electrodeposition, physical vapour deposition (PVD), chemical vapour deposition (CVD), atomic layer deposition (ALD), pulverisation, etc.

For example, the surface to be treated 100 can be that of a metallic layer 12 deposited, for example by electrodeposition, made of Au, Ag, Rh, Ru, Cu, Ni or Cr, and can have a thickness of between 10 nm and 20 μm. Optical effects are then advantageously produced by the slope formed by the change in thickness of the layer 12 generated by the ablation of the layer; in particular, the incident light is reflected differently depending on the angle formed by the slope and by any portions not affected by the laser treatment. Furthermore, the appearance of the horology component 10 can be matt on a laser-treated portion and brilliant on an untreated portion of layer 12, or vice versa.

In this case, an example of which is schematically represented in FIG. 4, the variation in thickness generates a variation in the colours of the horology component 10, insofar as the colour of the substrate 11 becomes more visible as the thickness of the layer 12 decreases. The treatment operation can be carried out so as to ablate the layer 12 to reduce its thickness locally until it is equal to a few tens of nanometers or until the layer 12 is removed.

Naturally, in a variant of this example, the surface to be treated 100 could be that of a coating of at least two layers, including an upper layer and a lower layer, with the treatment operation then being carried out so as to ablate the upper layer to reveal the lower layer and, if necessary, so as to ablate the lower layer to reveal the substrate 11.

If one or more thin layers are deposited by PVD, CVD or ALD, they can be made of silicon oxide, titanium, aluminium, a carbon-based material, chromium, gold, silver, aluminium, copper, nickel, etc. Advantageously, an interference effect can be generated such that the horology component 10 has an interference colour gradient. In this case, the thin layer or layers have a thickness comprised between 10 nm and 500 nm.

For example, the horology component 10 shown in FIG. 5 has a coating of thin layers comprising a metallic absorption layer 120, for example made of one of the aforementioned metals, deposited on the substrate 11, and a transparent layer 121 made of one of the aforementioned oxides and deposited on the absorption layer 120. The transparent layer 121 is at least semi-transparent in that it allows at least part of the luminous radiation to pass through. The transparent layer 121 is ablated during the treatment process so as to reduce its thickness locally, as shown in FIG. 5, in order to locally change an interference colour generated by the coating of thin layers.

In the case of one or more layers 12 deposited by pulverisation, the surface to be treated 100 can be made of transparent or non-transparent resin, for example acrylic, polyurethane, polyepoxides, etc., with or without colourant. In this case, the layer or layers 12 have a thickness comprised between 3 μm and 150 μm.

In another exemplary embodiment of the method, the treatment step is carried out such that the surface to be treated 100 is the surface of the substrate 11. The surface of the substrate 11 is structured so as to generate decorations consisting of reliefs with a uniform appearance on a micrometric scale, that is, an appearance that is free of aliasing.

In a variant of this exemplary embodiment of the method, the treatment step is carried out such that it generates a roughness gradient in the substrate 11, that is, a gradual change in the state of the surface of the substrate 11.

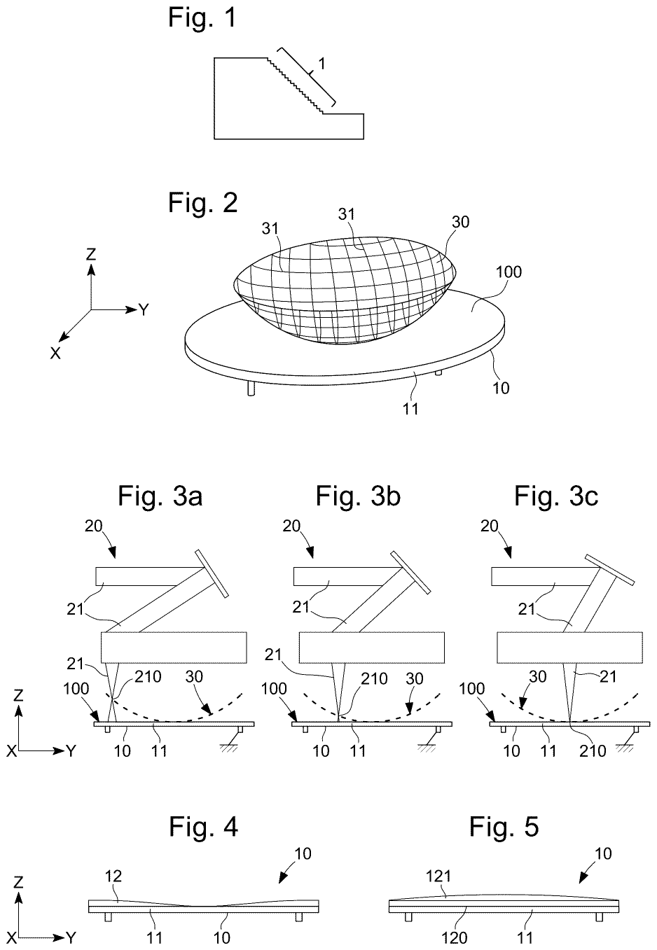

In general, irrespective of the surface area to be treated 100, as a result of the features of the invention, the aesthetic appearance of the horology component 10 is perfectly in line with the requirements of high-end horology, insofar as the treated surface does not exhibit any undesirable characteristics such as aliasing, characterised by successive shoulders as shown schematically in FIG. 1, or pixelation phenomena.

More generally, it should be noted that the embodiments and uses considered above have been described by way of non-limiting examples, and that other variants are therefore conceivable.

For example, the laser treatment operation can be carried out in several scans of the surface to be treated 100 according to a determined scanning step and a determined impulse overlap rate; these parameters are chosen according to the decoration to be generated on the surface to be treated 100 and do not, as such, relate to the present invention. This also applies to the power of the laser beam 21, the velocity at which the surface to be treated is scanned 100, the impulse duration, the wavelength of the laser beam 21, etc.

It should also be noted that prior to commencing the surface treatment operation, the substrate 11 can be textured by polishing, sandblasting, shot blasting, microblasting, sunray brushing, stamping, brushing, satin finishing, engine turning, engraving, milling, circling, circular graining or any other texturing operation.

1. A method for laser treatment of a horology component (10) comprising an operation for treating a surface of the horology component (10) inscribed in an orthonormal XYZ coordinate system, wherein a laser (20) is controlled to emit a laser beam (21) and to move a focal point (210) of the laser beam (21) in order to impact a surface to be treated (100) on the horology component (10) in response to control instructions from a computer program, in order to follow a scanning strategy comprising a plurality of paths (31), each having a component in a Z direction and a component in at least one of the X or Y directions, the scanning strategy being defined such that the energy density emitted by the laser beam (21) varies over the entire surface to be treated (100).

2. The method according to claim 1, wherein each of the paths (31) has a curvilinear and/or rectilinear shape.

3. The method according to claim 1, wherein the treatment operation is carried out by a laser (20) consisting of a numerically-controlled machine tool formed by a frame and a work enclosure in which the horology component (10) is disposed on a fitting.

4. The method according to claim 1, wherein the treatment operation is carried out so as to generate a colouration of the surface to be treated (100), the variation in the energy density of the laser beam (21) causing a gradual and direct variation in the colour of said surface to be treated (100).

5. The method according to claim 1, wherein the treatment operation is carried out so as to produce a decoration through the ablation of a layer (12) or of several layers of material deposited on the substrate (11), the variation in the energy density of the laser beam (21) causing a direct change in the thickness of the layer (12) on the surface of the substrate (11).

6. The method according to claim 5, wherein the surface to be treated (100) is the surface of a metallic layer (12) with a thickness comprised between 10 nm and 20 μm, the treatment operation being carried out such that the thickness of the layer (12) is reduced until it is equal to a few tens of nanometers or until the layer (12) is removed.

7. The method according to claim 5, wherein the surface to be treated (100) is the surface of a thin layer of silicon oxide, titanium, aluminium, a carbon-based material, chromium, gold, silver, aluminium, copper or nickel, deposited by PVD, CVD or ALD, so as to have a thickness comprised between 10 nm and 500 nm, the treatment operation being carried out such that the horology component (10) has an interference colour gradient.

8. The method according to claim 7, wherein the surface to be treated (100) is the surface of a layer in a coating of thin layers comprising a metallic absorption layer (120) deposited on the substrate (11) and a transparent layer (121) made of an oxide and deposited on the absorption layer (120), the treatment operation being carried out so as to ablate the transparent layer (121) to locally reduce its thickness in order to locally change an interference colour generated by the coating of thin layers.

9. The method according to claim 5, wherein the surface to be treated (100) is the surface of a layer (12) deposited by pulverisation with a thickness comprised between 3 μm and 150 μm.

10. The method according to claim 4, wherein the surface to be treated (100) is the surface of the substrate (11), the treatment operation being carried out such that said surface is structured so as to generate decorations in the form of reliefs with a uniform appearance on a micrometric scale.
